(19) United States
(12) Patent Application Publication
(10) Pub. No.: US 2013/0087621 A1
(43) Pub. Date: Apr. 11, 2013

(54) PRODUCING A CARD AND CARD HOLDER

(71) Applicant: Werner Vogt, Remetschwil (CH)

(72) Inventor: Werner Vogt, Remetschwil (CH)

(21) Appl. No.: 13/270,746

(22) Filed: Oct. 11, 2011

(51) Int. Cl. G06K 19/02; B41F 13/00; B41F 13/54; B41J 2/01

(52) U.S. Cl. 235/488; 347/104; 270/1.01

(57) ABSTRACT

Described are methods for producing a card. The methods include providing a transparent plastic layer, printing at least one first labeling layer of the card on the plastic layer, printing at least one middle layer of the card on the first labeling layer of the card, printing at least one second labeling layer of the card on the middle layer of the card, and severing the card from the layer arrangement. Also described are methods for simultaneously producing a card and a card holder. The methods further include producing a predetermined breaking point between the card and the card holder, and severing the card and card holder from the layer arrangement, with the card and the card holder remaining connected to each other by way of the predetermined breaking point.

### FIELD OF THE INVENTION

The invention relates generally to a method for producing a card and a card holder, for example, a gift card. The invention further relates to a method for simultaneously producing a card and a card holder.

### BACKGROUND OF THE INVENTION

Plastic cards currently have a wide variety of applications. They are used as gift cards, loyalty cards, referral cards, bonus cards, discount cards, employee badges, company IDs, visitor cards, club cards, access control cards, time recording cards, membership passes, ski passes, security passes, pharmacy cards, calendar cards, ID cards and many other purposes. The arrangement and dimensions of standard plastic cards are generally governed by ISO standards 7810 and 7813. They are usually produced by lamination. This means that they are pressed together from several layers of film under pressure and high temperature.

A four-layer film arrangement is usually used, which allows the production of an inseparable card body which is protected against wear and tear by transparent overlay films. PVC is mostly used as a material for the films, which raises environmental concerns since many plastic cards (e.g. gift cards) typically are disposable articles. The printing of the plastic cards is integrated into the production process, in that the core film of the cards is printed and is then pressed together with transparent films. An offset printing method is usually employed. Frequently, the plastic cards comprise additional functional and security features such as a signature panel, a magnetic stripe or a bar code. Personalization of the plastic cards usually occurs in a card printer by way of thermal transfer printing or dye sublimation printing.

Plastic cards to be sold in a retail business are frequently fastened to a holder for this purpose. It typically concerns a holder made of paper or cardboard which is provided with an opening, which allows suspending the holder on a store shelf. The plastic card is either inserted into an opening of this holder or is detachably connected with the holder by means of an adhesive.

The production of plastic cards is linked to a large number of production steps which entails respectively high production costs. Their personalization is also technically complex. If a plastic card such as a gift card is to be positioned on the holder, further production steps are necessary for this purpose.

It is an object of the present invention to provide a method for producing a card which can be performed at low cost with few production steps. It is especially also an object of the invention to connect the card with a low amount of technical effort with the holder and to further enable simple personalization of the card.

### SUMMARY OF THE INVENTION

In one aspect, there is a method for producing a card. The method includes providing a transparent plastic layer, printing at least one first labeling layer of the card on the plastic layer, printing at least one middle layer of the card on the first labeling layer of the card, printing at least one second labeling layer of the card on the middle layer of the card, and severing the card from the layer arrangement comprising the transparent plastic layer, the at least one first labeling layer, the at least one middle layer, and the at least one second labeling layer.

In another aspect, there is a method for simultaneously producing a card and a card holder. The method includes providing a transparent plastic layer, printing at least one first labeling layer of the card and the card holder on the plastic layer, printing at least one middle layer of the card and the card holder on the first labeling layer of the card and the card holder, printing at least one second labeling layer of the card and the card holder on the middle layer of the card and card holder, producing a predetermined breaking point between the card and the card holder, and severing the card and card holder from the layer arrangement comprising the transparent plastic layer, the at least one first labeling layer, the at least one middle layer, and the at least one second labeling layer, with the card and the card holder remaining connected to each other by way of the predetermined breaking point.

In another aspect, there is a card comprising a transparent plastic layer, at least one first labeling layer printed on the plastic layer, at least one middle layer printed on the first labeling layer, at least one second labeling layer printed on the middle layer, wherein the card is severed from the layer arrangement comprising the transparent plastic layer, the at least one first labeling layer, the at least one middle layer, and the at least one second labeling layer.

In other examples, any of the aspects above can include one or more of the following features. In some embodiments, a magnetic stripe is applied to the plastic layer before the printing of the first labeling layer, the magnetic stripe arranged in such a way that it forms a part of the card after the severing of the card. In some embodiments, the magnetic stripe is printed on the middle layer.

In some embodiments, the plastic layer consists of polyethylene terephthalate. In some embodiments, the printing occurs by a digital printing method. In some embodiments, the digital printing method is an inkjet printing method. In some embodiments, at least one of the printing of the first labeling layer and the printing of the second labeling layer comprises a personalization of the card.

In some embodiments, the severing of the card occurs by punching, milling, milling plotting or cutting. In some embodiments, the printing occurs by gang printing. In some embodiments, the card is a gift card.

A transparent plastic layer in accordance with embodiments of the invention is a plastic layer that is transparent within the visible wavelength range of light. A plastic layer that is translucent or opaque at least in a part of the visible wavelength range of light is considered to be non-transparent. At least one first labeling layer of the card will be printed on the plastic layer. In this process, letters and symbols are printed in a preferably mirror-inverted manner on the plastic layer, so that they can be read through the plastic layer. At least one middle layer of the card will be printed on the first labeling layer. It is used as a background for letters, symbols or images of the first labeling layer. At least one second labeling layer of the card will be printed on the middle layer of the card. After the completion of the printing process, the card will be severed from the layer arrangement which comprises the transparent plastic layer, at least one first labeling layer, at least one middle layer and at least one second labeling layer. A card is produced in this manner which comprises the transparent plastic layer on its one side, through which the labeling of the first labeling layer can be read before the background of the middle layer. The other side of the card is formed by the second labeling layer which can be read before the background of the middle layer. Since the second side of the card is therefore not formed by a plastic layer but by a color layer, the entire card surface is writable and can therefore be used as a signature panel.

The card can be provided with different security features. A barcode can represent a part of a labeling layer, for example, the second labeling layer of the card. The card can be provided with a magnetic stripe. The magnetic stripe can be applied to the plastic layer prior to the printing of the first labeling layer, where the stripe is arranged in such a way that, after severing the card, the stripe forms a part of the card. The first labeling layer, the middle layer and the second labeling layer are then printed around the magnetic stripe. The magnetic stripe is preferably arranged in such a way that it comprises a pattern and/or a label on the side facing the plastic layer, so that the stripe aesthetically matches the first labeling layer. The magnetic stripe can be printed with a magnetic ink on the middle layer. The second labeling layer is then printed around the magnetic stripe. The magnetic stripe can be applied to the plastic layer on the side facing away from the printing side.

The printing preferably occurs by an inkjet printing method. Printing of the first labeling layer and/or the printing of the second labeling layer can include personalization of the card. Personalization of a card can therefore occur during its production.

Since the transparent plastic layer does not concern a lamination layer, virtually any plastic material can be used—for example, an environmentally compatible plastic material—instead of the PVC that is usually used for producing plastic cards. As examples, acrylonitrile-butadiene-styrene (ABS), polycarbonate (PC) or polyethylene terephthalate (PET) can be used. The polyethylene terephthalate can also include recycled polyethylene terephthalate.

The severing of the card and optionally the cardholder from the layer arrangement can occur by punching, milling, milling plotting or cutting. These methods can also be used for producing the predetermined breaking point between the card and the card holder. Moreover, injection-molded parts can also be used which are then printed individually.

The method allows the inexpensive production of a plastic card in a few production steps, wherein the card can be produced jointly with the card holder. In particular, continuous card production is possible if the printing and the severing are performed at the same speed. It is especially advantageous that the printing can occur in blanks, wherein films of very large dimensions (e.g. 2 by 2 m² or even more) can be printed. A large number of cards and card holders can be produced in this manner by gang printing (or ganging up) with one printing process. A card in accordance with the invention can be labeled on one side without having to subsequently apply a signature panel for this purpose. Moreover, the card can already be personalized during the production process with little effort.

The details of one or more examples are set forth in the accompanying drawings and the description below. Further features, aspects, and advantages of the invention will become apparent from the description, the drawings, and the claims. The drawings are not necessarily to scale, emphasis instead generally being placed upon illustrating the principles of the invention.

### BRIEF DESCRIPTION OF THE DRAWINGS

The foregoing and other objects, features, and advantages of the present invention, as well as the invention itself, will be more fully understood from the following description of various embodiments, when read together with the accompanying drawings.

FIG. 1 is a cross-sectional view through the layer arrangement of a plastic card produced with a method according to an embodiment of the invention.

FIG. 2 is a top view of a plastic card and a card holder produced with a method according to an embodiment of the invention.

FIG. 3 is a cross-sectional view through the layer arrangement of a plastic card produced with a method according to an embodiment of the invention and contains a magnetic stripe.

FIG. 4 is a cross-sectional view through the layer arrangement of another plastic card produced with a method according to an embodiment of the invention and contains a magnetic stripe.

FIG. 5 is a cross-sectional view through the layer arrangement of yet another plastic card produced with a method according to an embodiment of the invention and contains a magnetic stripe.

### DETAILED DESCRIPTION

FIG. 1 is a cross-sectional view through the layer arrangement of a plastic card produced with a method according to an embodiment of the invention. For this purpose, a transparent film 1 made of PET with a thickness of 0.6 mm is provided. The specific thickness of the transparent film 1 provided herein is an example. It is possible to use thicker or thinner films. A first labeling layer 2 is printed with an inkjet printer on it in a mirror-inverted manner. A white middle layer 3, for example, is then printed on the first labeling layer 2. Finally, a second labeling layer 4 is printed on the middle layer 3, which second labeling layer 4 can comprise a barcode. Any desired digital print method can be used. The method is therefore not limited to inkjet printing technology.

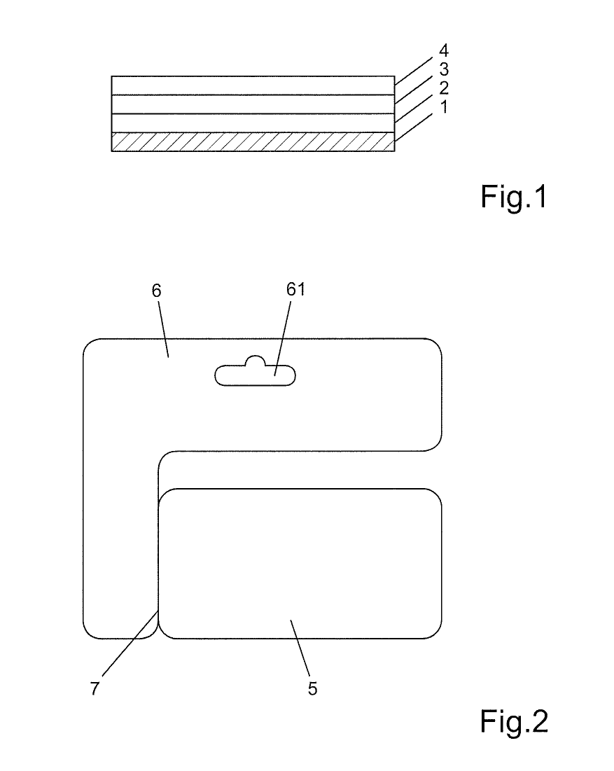

A card holder can simultaneously be produced in an advantageous manner in addition to the card according to the method. For this purpose, the layer arrangement of the card holder 6 is printed simultaneously with the layer arrangement of the card 5, as shown in FIG. 2. Thereafter, a predetermined breaking point 7 is produced by means of milling plotting between the card 5 and the card holder 6. The card 5 and the card holder 6 are severed from the layer arrangement in such a way that the card 5 and the card holder 6 remain connected with one another by way of the predetermined breaking point 7. In addition to this technique of singularization of the individual cards plus cardholders, injection-molded parts can be used which are then printed separately. This could also occur in the blank. In this case, an opening 61 is milled into the card holder 6 which allows suspending the card holder 6 on a store shelf The printing of at least one of the two labeling layers 2, 4 can comprise the personalization of the card 5.

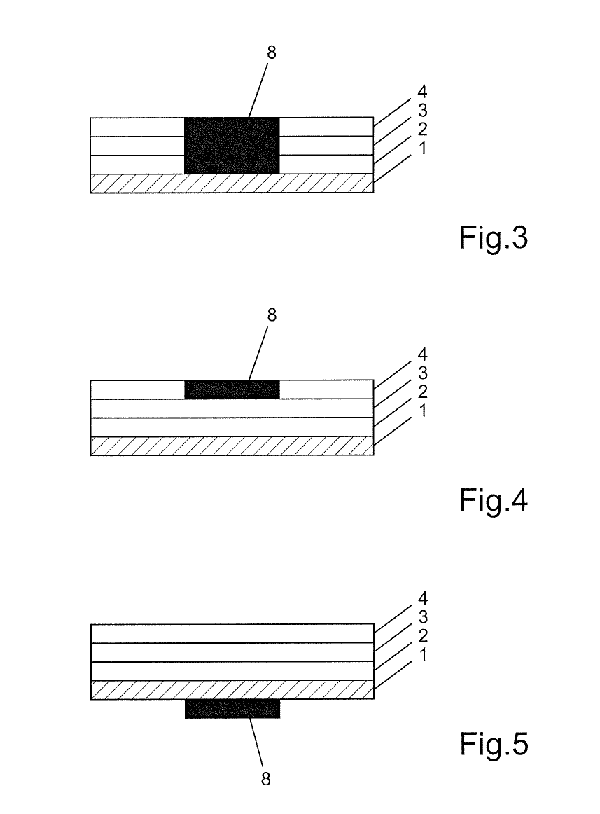

In accordance with a further embodiment of the invention, a card can be produced which comprises a magnetic stripe. FIG. 3 is a cross-sectional view through the layer arrangement of a plastic card 5 which was produced with according to an embodiment of the invention and contains a magnetic stripe 8. For this purpose, the magnetic stripe 8 is applied to the transparent PET layer 1 and thereafter the first labeling layer 2, the middle layer 3 and the second labeling layer 4 are printed around magnetic stripe 8.

In yet a further embodiment of the invention the first labeling layer 2 and the middle layer 3 are successively applied at first to the PET layer 1, as shown in FIG. 4. A magnetic stripe 8 is printed thereafter with a magnetic ink on the middle layer 3 and the second labeling layer 4 is printed around the magnetic stripe 8.

In yet another embodiment, the arrangement of the labeling layer 2, shown in FIG. 5, the middle layer 3 and the labeling layer 4 is arranged on one side of the transparent PET layer 1 and the magnetic stripe 8 is applied to the side of the PET layer 1 which faces away from the layer arrangement.

In accordance with the invention, plastic cards, especially gift cards, can therefore be produced in a simple way and can be provided with security features such as barcodes or magnetic stripes. Personalization of the card can occur during its production. Moreover, the card and the card holder can be integrally produced in one and the same production process. The described method is also suitable for oversized ID cards such as are commonly used at sporting events, for example. The large ID cards allow recognizing an authorization even from a larger distance. One advantage of the described method can especially be seen in such a way that it is not subject to predetermined eyelets of the ID cards to be produced. ID cards, gift cards or other cards can be produced in any desired size in an advantageous manner.

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention can be thus indicated by the appended claims, rather than by the foregoing description, and all changes that come within the meaning and range of equivalency of the claims are therefore intended to be embraced therein.

What is claimed is:

1. A method for producing a card, comprising:
providing a transparent plastic layer;
printing at least one first labeling layer of the card on the plastic layer;
printing at least one middle layer of the card on the first labeling layer of the card;
printing at least one second labeling layer of the card on the middle layer of the card; and
severing the card from the layer arrangement comprising the transparent plastic layer, the at least one first labeling layer, the at least one middle layer, and the at least one second labeling layer.

2. The method of claim 1, wherein a magnetic stripe is applied to the plastic layer before the printing of the first labeling layer, the magnetic stripe arranged in such a way that it forms a part of the card after the severing of the card.

3. The method of claim 2, wherein the magnetic stripe is printed on the middle layer.

4. The method of claim 1, wherein the plastic layer consists of polyethylene terephthalate.

5. The method of claim 1, wherein the printing occurs by a digital printing method.

6. The method of claim 5, wherein the digital printing method is an inkjet printing method.

7. The method of claim 1, wherein at least one of the printing of the first labeling layer and the printing of the second labeling layer comprises a personalization of the card.

8. The method of claim 1, wherein the severing of the card occurs by punching, milling, milling plotting or cutting.

9. The method of claim 1, wherein the printing occurs by gang printing.

10. A method for simultaneously producing a card and a card holder, comprising:
providing a transparent plastic layer;
printing at least one first labeling layer of the card and the card holder on the plastic layer;
printing at least one middle layer of the card and the card holder on the first labeling layer of the card and the card holder;
printing at least one second labeling layer of the card and the card holder on the middle layer of the card and card holder;
producing a predetermined breaking point between the card and the card holder; and
severing the card and card holder from the layer arrangement comprising the transparent plastic layer, the at least one first labeling layer, the at least one middle layer, and the at least one second labeling layer, with the card and the card holder remaining connected to each other by way of the predetermined breaking point.

11. The method of claim 10, wherein a magnetic stripe is applied to the plastic layer before the printing of the first labeling layer, the magnetic stripe arranged in such a way that it forms a part of the card after the severing of the card.

12. The method of claim 11, wherein the magnetic stripe is printed on the middle layer.

13. The method of claim 10, wherein the plastic layer consists of polyethylene terephthalate.

14. The method of claim 10, wherein the printing occurs by a digital printing method.

15. The method of claim 14, wherein the digital printing method is an inkjet printing method.

16. The method of claim 10, wherein at least one of the printing of the first labeling layer and the printing of the second labeling layer comprises a personalization of the card.

17. The method of claim 10, wherein the severing of the card occurs by punching, milling, milling plotting or cutting.

18. The method of claim 10, wherein the printing occurs by gang printing.

19. A card, comprising:
a transparent plastic layer;
at least one first labeling layer printed on the plastic layer;
at least one middle layer printed on the first labeling layer;
at least one second labeling layer printed on the middle layer, wherein the card is severed from the layer arrangement comprising the transparent plastic layer, the at least one first labeling layer, the at least one middle layer, and the at least one second labeling layer.

20. The card of claim 10, wherein the card is a gift card.
